(19) United States
(12) Patent Application Publication
(10) Pub. No.: US 2017/0351039 A1
(43) Pub. Date: Dec. 7, 2017

(54) CLEANING TOOL AND CLEANING METHOD

(71) Applicant: FUJIKURA LTD., Tokyo (JP)

(72) Inventors: Junichi Nakane, Chiba (JP); Kunihiko Fujiwara, Chiba (JP)

(73) Assignee: FUJIKURA LTD., Tokyo (JP)

(21) Appl. No.: 15/616,499

(22) Filed: Jun. 7, 2017

(30) Foreign Application Priority Data
Jun. 7, 2016 (JP) 2016-113315

(51) Int. Cl. G02B 6/38; B08B 1/00

(52) U.S. Cl. CPC G02B 6/3866; B08B 1/006

(57) ABSTRACT

A cleaning tool includes a head member that presses a cleaning element at a pressing face against a cleaning target; a feed mechanism that supplies the cleaning element to the pressing face and that collects the cleaning element from the pressing face; and a liquid supply section that supplies a liquid cleaner and moistens the cleaning element at the pressing face with the liquid cleaner.

### TECHNICAL FIELD

The present disclosure relates to a cleaning tool and cleaning method.

### BACKGROUND ART

Connection between optical connectors is achieved by abutting optical fiber end faces present at connection end faces (ferrule end faces) of the optical connectors. When there is dirt adhering to the connection end face of the optical connector or to the optical fiber end face, then this causes damage to the optical connector or the optical fiber, or causes an increase in transmission loss, or the like. There is accordingly a need to clean the connection end face of the optical connector prior to the abutting/connection. Patent Literature 1 discloses an example of a cleaning tool. This cleaning tool includes a tool body, and an insertion section (extending section) with a head member to press a cleaning element against the connection end face of the optical connector. In this cleaning tool, the tool body is moved with respect to the insertion section in a state in which the cleaning element is pressed against the optical connector; this causes the cleaning element to be supplied and collected and also causes the head member to rotate, thereby enabling the cleaning element to wipe the connection end face of the optical connector.

### CITATION LIST

### Patent Literature

Patent Literature 1: Japanese Patent No. 4579330

In cases in which dirt is strongly adhered to the connection end face of an optical connector or to an optical fiber end face, sometimes the dirt cannot be removed even when cleaning is performed with a dry cleaning element of a cleaning tool. In such cases, for example, an operator soaks a cotton bud in a liquid cleaner such as alcohol, and removes the strongly adhered dirt from the end face. However, in such a cleaning method, not only does the cleaning operation take some effort to perform, but also there is a large difference in the cleaning techniques of operators.

A cleaning tool capable of easily removing strongly adhered dirt may, thus, be beneficial.

### SUMMARY OF INVENTION

One or more embodiments of the invention concern a cleaning tool including: a head member to press a cleaning element at a pressing face against a cleaning target; a feed mechanism to supply the cleaning element to the pressing face and to collect the cleaning element from the pressing face; and a liquid supply section to supply a liquid cleaner so as to moisten the cleaning element at the pressing face with the liquid cleaner.

Other features of embodiments of the invention are made clear by the Description and Drawings below.

### Advantageous Effects of Embodiments of the Invention

One or more embodiments of the invention enable strongly adhered dirt to be removed easily.

### BRIEF DESCRIPTION OF DRAWINGS

FIG. 1 is an overall perspective view of a cleaning tool 1 of a first embodiment.

FIG. 2 is a diagram illustrating an internal configuration of a tool body 10 of the cleaning tool 1.

FIG. 3 is a diagram illustrating internal configuration of an insertion section 20 of the cleaning tool 1.

FIG. 4A and FIG. 4B are perspective views of a vicinity of a leading end of the cleaning tool 1.

FIG. 5A is a diagram illustrating an example of configuration of a liquid supply section 30. FIG. 5B and FIG. 5C are diagrams illustrating configurations of different chambers 31.

FIG. 6A is an explanatory diagram of a situation in which a liquid cleaner 5 has been dispensed from a dispensing port 37A. FIG. 6B illustrates a range over which the liquid cleaner 5 has permeated the cleaning element 3 after supply of a predetermined amount of the liquid cleaner 5.

FIG. 7A is a perspective view of an insertion section 20 of a cleaning tool 1 of a second embodiment. FIG. 7B is an explanatory diagram of a pressing face 22 of a head member 21 and a dispensing port 37A of a liquid supply section 30 of the second embodiment.

FIG. 8A is an explanatory diagram of a positional relationship between a cleaning element 3 and the dispensing port 37A at the pressing face 22. FIG. 8B is an explanatory diagram of a trajectory of the cleaning element 3 and a trajectory of the dispensing port 37A when the head member 21 is rotated during cleaning.

FIG. 9A is a diagram illustrating an internal configuration of a tool body 10 of a cleaning tool 1 of a third embodiment. FIG. 9B is a diagram illustrating an internal configuration of an insertion section 20 of the cleaning tool 1 of the third embodiment.

FIG. 10A is a diagram illustrating an internal configuration of a tool body 10 of a cleaning tool 1 of a fourth embodiment. FIG. 10B is a diagram illustrating an internal configuration of an insertion section 20 of the cleaning tool 1 of the fourth embodiment.

### DETAILED DESCRIPTION OF EMBODIMENTS

At least the following matters are made clear from the Description and Drawings described below.

Disclosed are embodiments of a cleaning tool including: a head member to press a cleaning element at a pressing face against a cleaning target; a feed mechanism to supply the cleaning element to the pressing face and to collect the cleaning element from the pressing face; and a liquid supply section to supply a liquid cleaner so as to moisten the cleaning element at the pressing face with the liquid cleaner. Such a cleaning tool can easily remove strongly adhered dirt.

In one or more embodiments of the invention, the liquid supply section includes an open-close section capable of blocking a flow path of the liquid cleaner; and the liquid cleaner flows in the flow path and is supplied when the open-close section has opened the flow path. With this configuration, the liquid cleaner can be supplied and blocked.

In one or more embodiments of the invention, an operation section is provided to operate the open-close section. This may enable an operator to decide whether or not there is a need to moisten the cleaning element.

In one or more embodiments of the invention, the cleaning tool further includes a tool body, and an insertion section including the head member and capable of moving in a predetermined direction relative to the tool body; and the open-close section is opened or closed by relative movement between the tool body and the insertion section when cleaning the cleaning target by moving the tool body and the insertion section relative to each other while pressing the cleaning element at the pressing face against the cleaning target. This may enable prevention of forgetting to moisten the cleaning element during cleaning.

In one or more embodiments of the invention, a predetermined amount of the liquid cleaner is supplied when the open-close section has opened the flow path. This may enable oversupply of the liquid cleaner to be suppressed from occurring.

In one or more embodiments of the invention, when the predetermined amount of the liquid cleaner has been supplied, the liquid cleaner permeates the cleaning element up to the pressing face. This may enable the cleaning target to be moistened with the liquid cleaner at the stage when the cleaning element has contacted the cleaning target during cleaning.

In one or more embodiments of the invention, L1<L2 is satisfied, wherein L1 is a length up to the pressing face from an upstream end of a range over which the liquid cleaner has permeated the cleaning element when the predetermined amount of the liquid cleaner has been supplied, and L2 is a length of the cleaning element fed by the feed mechanism when cleaning the cleaning target by pressing the cleaning element at the pressing face against the cleaning target. This may enable dry cleaning to be performed after wet cleaning has been performed.

In one or more embodiments of the invention, when cleaning the cleaning target by pressing the cleaning element at the pressing face against the cleaning target, at the pressing face, a portion of the cleaning element not permeated by the liquid cleaner is pressed against the cleaning target after a portion of the cleaning element permeated by the liquid cleaner has been pressed against the cleaning target. This may enable residue of the liquid cleaner to be suppressed from remaining since dry cleaning is performed after wet cleaning has been performed.

In one or more embodiments of the invention, the liquid supply section includes a dispensing port to dispense the liquid cleaner to the cleaning element. This may enable the liquid cleaner to be dispensed directly to the cleaning element.

In one or more embodiments of the invention, the head member includes a guide to guide the cleaning element at the dispensing port. This may enable the liquid cleaner to be suppressed from spilling.

In one or more embodiments of the invention, the cleaning element has a strip shape. This may enable the liquid cleaner to be suppressed from spilling.

In one or more embodiments of the invention, the liquid supply section includes a dispensing port facing the cleaning target; and the liquid cleaner dispensed from the dispensing port contacts the cleaning element when cleaning the cleaning target by pressing the cleaning element at the pressing face against the cleaning target. This may enable the cleaning element to be indirectly moistened with the liquid cleaner.

In one or more embodiments of the invention, the head member is configured so as to rotate when cleaning the cleaning target by pressing the cleaning element at the pressing face against the cleaning target; and a trajectory of the dispensing port when the head member is rotated and a trajectory of the cleaning element at the pressing face when the head member is rotated overlap with each other. This may make it easier to indirectly moisten the cleaning element with the liquid cleaner.

In one or more embodiments of the invention, the cleaning element is fed from an upstream side to a downstream side at the pressing face when cleaning the cleaning target by pressing the cleaning element at the pressing face against the cleaning target; and a trajectory of the dispensing port when the head member is rotated and a trajectory of the cleaning element on the upstream side at the pressing face when the head member is rotated overlap with each other. This may result in an effective configuration for wet cleaning.

In one or more embodiments of the invention, the head member is configured so as to perform a to-and-fro reciprocating rotation when cleaning the cleaning target by pressing the cleaning element at the pressing face against the cleaning target; and an initial position of the dispensing port prior to rotation of the head member and a trajectory of the cleaning element on the upstream side at the pressing face when the head member is rotated during an outbound path overlap with each other. This may make it easier to indirectly moisten the cleaning element with the liquid cleaner partway along an outbound path.

Disclosed is a cleaning method in accordance with one or more embodiments of the invention, involving: supplying a cleaning element to a pressing face of a head member and collecting the cleaning element from the pressing face; supplying a liquid cleaner to moisten the cleaning element at the pressing face with the liquid cleaner; and pressing the cleaning element moistened with the liquid cleaner against the cleaning target at the pressing face. According to such a cleaning method, strongly adhered dirt can be easily removed.

### First Embodiment

First a basic configuration of a cleaning tool 1, in accordance with one or more embodiments of the invention, will be described, and then a liquid supply section 30 of the cleaning tool 1 will be described.

### <Cleaning Tool 1 Basic Configuration>

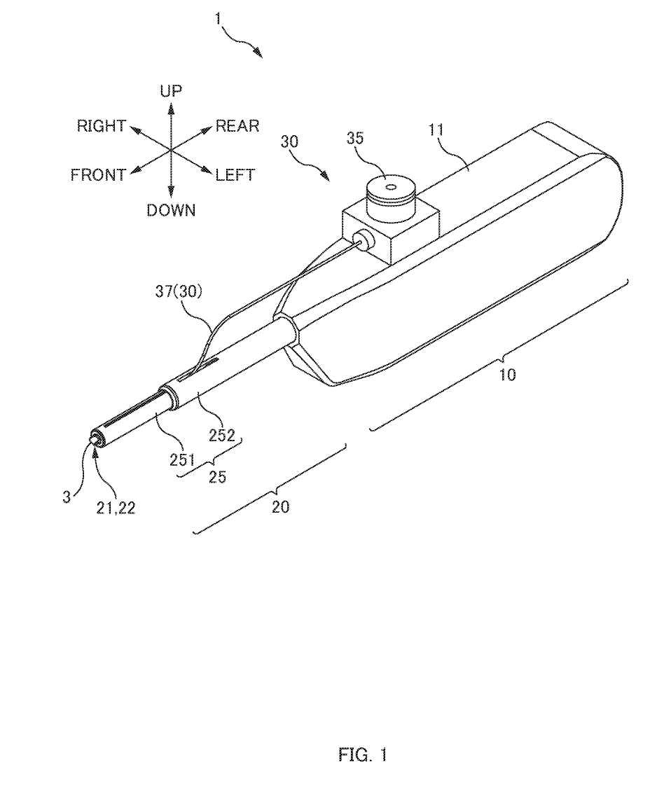

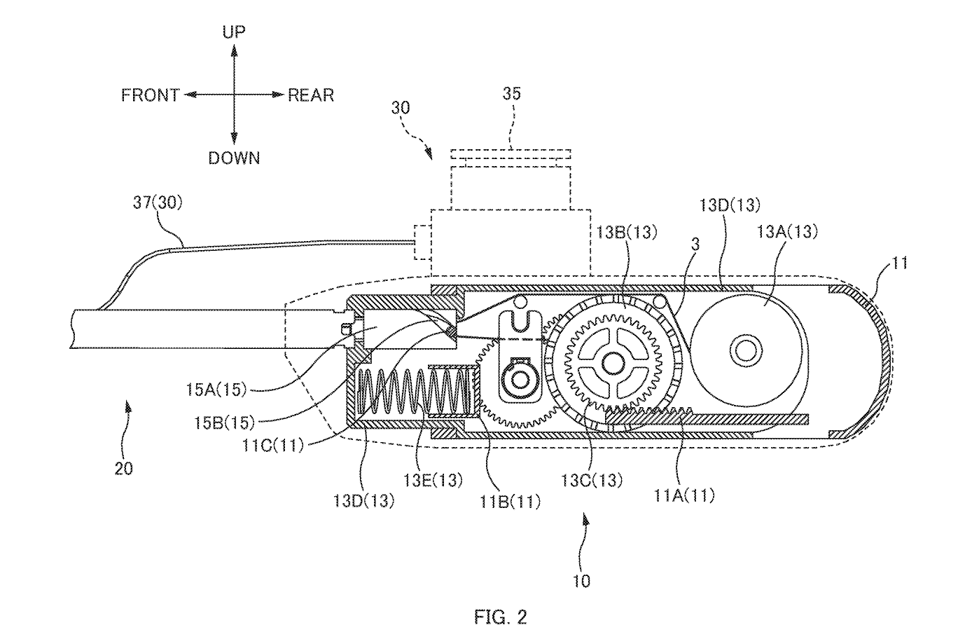

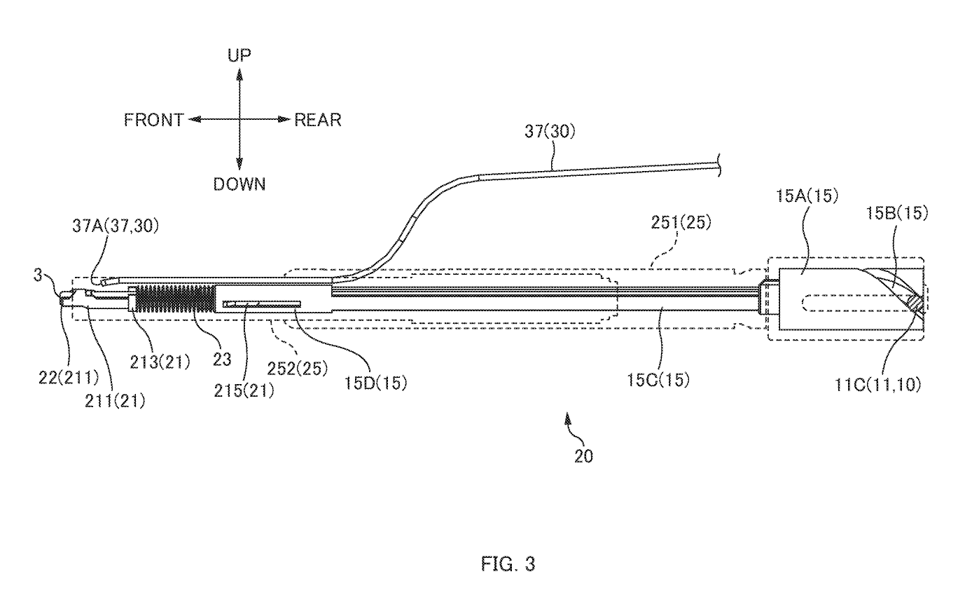

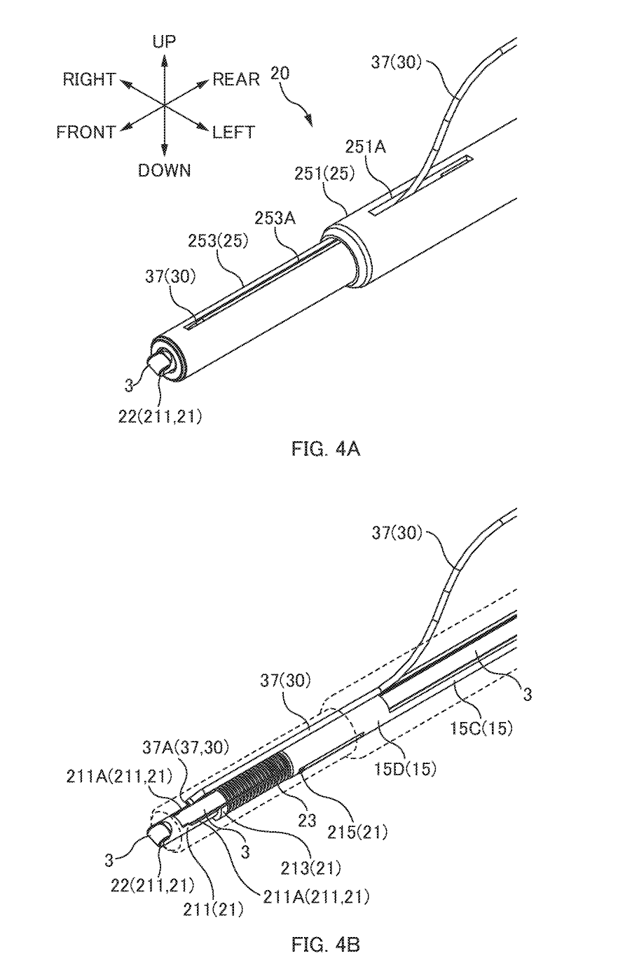

FIG. 1 is an overall perspective view of a first embodiment of the cleaning tool 1. FIG. 2 is a diagram illustrating an internal configuration of a tool body 10 of the cleaning tool 1. FIG. 3 is a diagram illustrating an internal configuration of an insertion section 20 of the cleaning tool 1. FIG. 4A and FIG. 4B are perspective views of a vicinity of a leading end of the cleaning tool 1.

In the following description each direction is defined as indicated in the drawings. Namely, a direction in which the insertion section 20 extends out from the tool body 10 is the “front-rear” direction, with the side of the insertion section 20 as viewed from the tool body 10 as the “front” and the opposite side the “rear”. An axial direction of a rotation shaft of a take-up reel 13B in the tool body 10 is the “left-right direction”, with the right side when viewed from the rear toward the front as the “right”, and the opposite side thereto as the “left”. A direction perpendicular to both the front-rear direction and the left-right direction is the “top-bottom direction”.

In one or more embodiments of the invention, the cleaning tool 1 is a tool to clean a ferrule end face (optical fiber end face) of an optical connector. The cleaning tool 1 includes a head member 21 and a feed mechanism 13 to supply a cleaning element 3 and to collect the cleaning element 3. A pressing face 22 (head face) is provided at the end of the head member 21, and the cleaning element 3 is entrained around the pressing face 22. The cleaning tool 1 includes the tool body 10, and the insertion section 20 that is capable of moving in the front-rear direction relative to the tool body 10. The feed mechanism 13 utilizes relative movement between the tool body 10 and the insertion section 20 during cleaning to supply unused cleaning element 3 to the pressing face 22, and to collect the used cleaning element 3 (described later).

In order to clean an optical connector using the cleaning tool 1, an operator may hold the tool body 10 in his/her hand, and may insert the leading end of the insertion section 20 into an optical adaptor, may press the cleaning element 3 at the pressing face 22 against the optical connector inside the optical adaptor, and in this state may move the tool body 10 forward (a push action). The operator then may pull the insertion section 20 out from the optical adaptor (a pull action). The push action and the pull action may be performed in this manner during the cleaning action. In the push action, the tool body 10 moves forward relative to the insertion section 20, and, as viewed from the tool body 10, the insertion section 20 moves rearward relative to the tool body 10. In the pull action, the tool body 10 moves rearward relative to the insertion section 20, and, as viewed from the tool body 10, the insertion section 20 moves forward relative to the tool body 10.

As described above, in one or more embodiments of the invention, relative movement between the tool body 10 and the insertion section 20 in the front-rear direction during cleaning is utilized by the feed mechanism 13 to supply the cleaning element 3 and to collect the cleaning element 3. However, the feed mechanism 13 may supply the cleaning element 3 and collect the cleaning element 3 using another method. For example, a circular disc shaped dial may be provided, and the operator may supply the cleaning element 3 and collect the cleaning element 3 by rotating the dial. A cleaning tool 1 equipped with such a feed mechanism 13, in accordance with an embodiment of the invention, does not need to move the tool body 10 and the insertion section 20 relative to each other in the front-rear direction. Moreover, in one or more embodiments, the relative movement between the tool body 10 and the insertion section 20 in the front-rear direction during cleaning may further be utilized to rotate the head member 21 in a rotation direction about an axis along the front-rear direction. However, there is no necessity for the head member 21 to rotate.

In one or more embodiments the cleaning element 3 is strip shaped (tape shaped) having a degree of width. Employing the strip shaped cleaning element 3 enables reliable cleaning of the optical fiber end face at the end face of the optical connector. However, the shape of the cleaning element 3 is not limited to being strip shaped, and may be thread shaped. The cleaning element 3 is preferably configured by a nonwoven fabric or a woven fabric using fibers of polyester, nylon, or the like. However, the material and form of the cleaning element 3 is not limited thereto.

As described above, the cleaning tool 1, in accordance with one or more embodiments of the invention, includes the tool body 10 and the insertion section 20.

The tool body 10 is a section that may be gripped by an operator during cleaning. The tool body 10 includes a case body 11 and the feed mechanism 13.

In one or more embodiments of the invention, the case body 11 is a housing body that internally houses the cleaning element 3, the feed mechanism 13 that supplies the cleaning element 3 and collects the cleaning element 3, and the like. As illustrated in FIG. 2, a rack 11A and a spring seat 11B are fixed to the case body 11. The rack 11A is a section that configures a rack and pinion mechanism together with a gear of the feed mechanism 13. The rack and pinion mechanism converts front-rear direction linear motion of the tool body 10 and the insertion section 20 into rotary motion during cleaning. The spring seat 11B is a section provided on an inner wall face of the case body 11, and is a section making contact with one end (the rear end) of a coil spring 13E, and retaining the one end of the coil spring 13E. A pin shaped insertion protrusion 11C is formed on an inner wall face (the left inner wall face) of the case body 11, and projects out toward the inside (the right side). The insertion protrusion 11C fits into a cam groove 15B of a rotating cylinder 15A of a rotating body 15, and, together with the cam groove 15B, configures a rotation mechanism (a mechanism to rotate the rotating body 15: described later).

In one or more embodiments of the invention, the feed mechanism 13 is a mechanism to supply the cleaning element 3 and to collect the cleaning element 3. The feed mechanism 13 includes a supply reel 13A, the take-up reel 13B, a pinion 13C (gear), a moving body 13D, and the coil spring 13E (see FIG. 2).

In one or more embodiments of the invention, the supply reel 13A is a reel to supply unused cleaning element 3. The unused cleaning element 3 is wound onto the supply reel 13A. The take-up reel 13B is a reel to take up the used cleaning element 3 and to collect the used cleaning element 3.

In one or more embodiments of the invention, the pinion 13C is a section that, together with the rack 11A fixed to the case body 11, configures the rack and pinion mechanism. A transmission mechanism is interposed between the pinion 13C and the take-up reel 13B. Configuration is made such that when the pinion 13C rotates in a predetermined direction, the take-up reel 13B also rotates; however, when the pinion 13C rotates in the opposite direction, the rotation force therefrom is not transmitted to the take-up reel 13B, and the take-up reel 13B does not rotate. This means that the take-up reel 13B only rotates in a direction to take-up the cleaning element 3 (the take-up direction).

In one or more embodiments of the invention, the moving body 13D is a member that moves together with the insertion section 20 in the front-rear direction relative to the case body 11. The moving body 13D supports the supply reel 13A, the take-up reel 13B, and the pinion 13C, so as to each be rotatable. When the tool body 10 and the insertion section 20 are moved relative to each other in the front-rear direction during cleaning, inside the case body 11, the moving body 13D moves relative to the case body 11 in the front-rear direction. Due to the pinion 13C being rotated by this relative movement, the take-up reel 13B rotates in the take-up direction and collects the cleaning element 3, and unused cleaning element 3 of an amount equivalent to the amount collected onto the take-up reel 13B is supplied from the supply reel 13A. A spring seat is provided on the moving body 13D. The spring seat is a section that contacts one end (the front end) of the coil spring 13E, and retains the one end of the coil spring 13E. The moving body 13D rotatably supports the rotating cylinder 15A of the rotating body 15.

In one or more embodiments of the invention, the coil spring 13E is a member to restore the positional relationship between the tool body 10 and the insertion section 20. The coil spring 13E is disposed between the case body 11 and the moving body 13D. More specifically, the front end of the coil spring 13E is retained in the spring seat of the moving body 13D, and the rear end of the coil spring 13E is retained in the spring seat 11B of the case body 11. When the insertion section 20 is moved rearward relative to the tool body 10 during cleaning, inside the case body 11, the moving body 13D moves rearward relative to the case body 11, causing the coil spring 13E to undergo compression deformation. When the coil spring 13E that has been compression deformed rebounds, the moving body 13D returns to its original position inside the case body 11, causing the insertion section 20 to move forward with respect to the tool body 10 and return to its original position.

As described above, in one or more embodiments, the cleaning tool 1 utilizes the relative movement between the tool body 10 and the insertion section 20 in the front-rear direction during cleaning to rotate the head member 21 pressing the cleaning element 3 against the optical connector. The cleaning tool 1, in one or more embodiments, accordingly includes the rotating body 15 to rotate the head member 21.

In one or more embodiments of the invention, the rotating body 15 is a member that performs to-and-fro reciprocating rotation (outbound and return rotation) about an axis lying along the front-rear direction, and rotates the head member 21. The rotating body 15 includes the rotating cylinder 15A, a guide 15C, and a head support 15D (see FIG. 3).

In one or more embodiments of the invention, the rotating cylinder 15A is a cylindrical shaped location including the helical shaped cam groove 15B. The rotating cylinder 15A is rotatably supported by the moving body 13D of the tool body (see FIG. 2), and moves together with the moving body 13D (and the insertion section 20) relative to the case body 11 in the front-rear direction. The cam groove 15B is a groove formed in a helical shape in the outer surface of the rotating cylinder 15A. The pin shaped insertion protrusion 11C projecting out from the inner wall face (the left wall face) of the case body 11 toward the inside (the right side) fits into the cam groove 15B. The cam groove 15B is a section that, together with the insertion protrusion 11C, configures a rotation mechanism to rotate the rotating body 15. The rotation mechanism configured by the cam groove 15B and the insertion protrusion 11C utilizes the relative movement (linear motion) between the tool body 10 and the insertion section 20 in the front-rear direction during cleaning to rotate the rotating body 15. The rotating cylinder 15A is formed hollow, wherein the unused cleaning element 3 supplied from the supply reel 13A onto the pressing face 22 is inserted through the rotating cylinder 15A in the front-rear direction, and the used cleaning element 3 collected from the pressing face 22 onto the take-up reel 13B is inserted through the rotating cylinder 15A in the front-rear direction.

In one or more embodiments of the invention, the guide 15C is a section to guide the cleaning element 3 in the front-rear direction. The guide 15C is a section formed along the front-rear direction in a long-thin plate shape. One plate face of the guide 15C guides the unused cleaning element 3 supplied from the supply reel 13A onto the pressing face 22, and the other plate face guides the used cleaning element 3 collected from the pressing face 22 onto the take-up reel 13B. The guide 15C is disposed in front of the rotating cylinder 15A, and is housed primarily in the insertion section 20. The guide 15C is integrally configured with the rotating cylinder 15A.

In one or more embodiments of the invention, the head support 15D is a section that supports the head member 21. The head support 15D supports the head member 21 so as to enable the head member 21 to retract when the cleaning element 3 at the pressing face 22 is pressed against the optical connector. The head support 15D supports the head member 21 while restricting (limiting) relative movement in a rotation direction such that there is no relative movement between the head support 15D and the head member 21 in the rotation direction. Hence, when the rotating body 15 rotates about the axis along the front-rear direction, the head member 21 also rotates together with the rotating body 15. Note that the front end of the head support 15D contacts the rear end of a head spring 23.

In one or more embodiments of the invention, the insertion section 20 is a section inserted into an insertion port of a cleaning target (an optical connector), and is provided so as to project forward from the tool body 10. The insertion section 20 is able to move in the front-rear direction relative to the tool body 10. The insertion section 20 includes the head member 21, the head spring 23 and a cylinder body 25.

In one or more embodiments of the invention, the head member 21 is a member that presses the cleaning element 3 against the optical connector, which is the cleaning target. The head member 21 includes a head 211, a flange 213, and a base end 215 (see FIG. 3, FIG. 4A and FIG. 4B).

In one or more embodiments of the invention, the head 211 is a section positioned in front of the head member 21, and is a section that presses the cleaning element 3 against the cleaning target. The front end face of the head 211 is configured by the pressing face 22 (head face) to press the cleaning element 3 against the cleaning target. The cleaning element 3 is entrained around the pressing face 22. The head 211 is positioned at an end of the insertion section 20, and the cleaning element 3 entrained around the pressing face 22 is externally exposed so as to press the cleaning element 3 against the optical connector.

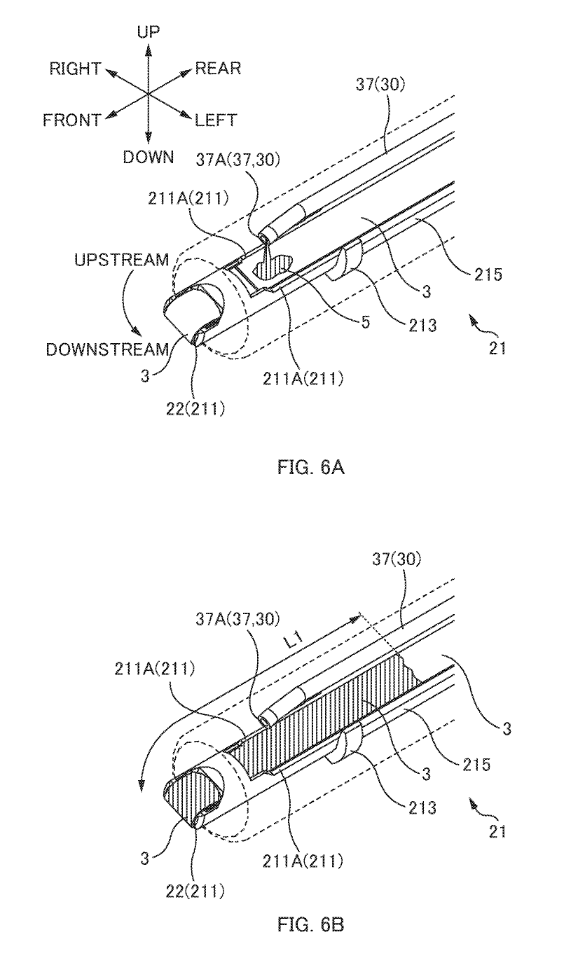

In one or more embodiments of the invention, the head 211 includes guides 211A to guide the cleaning element 3 along the front-rear direction. The guides 211A are formed by ridges along the front-rear direction at the outside of both the left and right edges of the cleaning element 3 so as to contact the both the left and right edges of the cleaning element 3. In one or more embodiments, such guides 211A are formed in the vicinity of a dispensing port 37A. This thereby enables a liquid cleaner 5 to be suppressed from spilling out from the cleaning element 3 by the guides 211A (see FIG. 6A).

In one or more embodiments of the invention, the flange 213 is a section rearward of the head 211, and has an external periphery that projects out more than that of the head 211. The flange 213 contacts the front end of the head spring 23, and the head member 21 is pressed forward by the head spring 23 through the flange 213.

In one or more embodiments of the invention, the base end 215 is a section to the rear of the flange 213. The base end 215 is supported by the head support 15D so as to be able to retract while being restricted in rotational movement relative to the head support 15D.

The head spring 23 is inserted into the base end 215.

In one or more embodiments of the invention, the head spring 23 is an elastic member to press the head member 21 forward. The head spring 23 is disposed in a compression deformed state between the flange 213 of the head member 21 and the head support 15D of the rotating body 15. This enables the cleaning element 3 at the pressing face 22 of the head member 21 to be pressed against the optical connector with a predetermined pressing force.

In one or more embodiments of the invention, the cylinder body 25 is a member (cover) to cover the cleaning element 3 at the insertion section 20. The cylinder body 25 is coupled to the moving body 13D of the tool body 10, and is capable of moving in the front-rear direction relative to the tool body 10. The cylinder body 25 includes a base cylinder section 251 on the tool body 10 side (the base end side) and a leading end cylinder section 253 on the head member 21 side (the front side, the leading end side). The base cylinder section 251 and the leading end cylinder section 253 may be configured integrally to each other.

As illustrated in FIG. 4A, in one or more embodiments, a lead-in hole 251A is formed in the base cylinder section 251 to lead a tube 37 serving as a supply channel for the liquid cleaner 5 into the leading end cylinder section 253. A retention groove 253A is also formed in the leading end cylinder section 253 to retain the tube 37. The liquid cleaner 5 and the tube 37 are described later.

### <Liquid Supply Section 30>

As already described, the cleaning tool 1, in accordance with one or more embodiments includes the liquid supply section 30 that moistens the cleaning element 3 with the liquid cleaner 5 (see FIG. 1). This enables strongly adhered dirt to be easily removed due to being able to press the moistened cleaning element 3 at the pressing face 22 of the head member 21 against the cleaning target.

In one or more embodiments of the invention, the liquid cleaner 5 is a liquid to clean the cleaning target. The liquid cleaner 5 is, for example, pure water, alcohol, or the like. The liquid cleaner 5 is preferably a liquid that leaves not residue after drying.

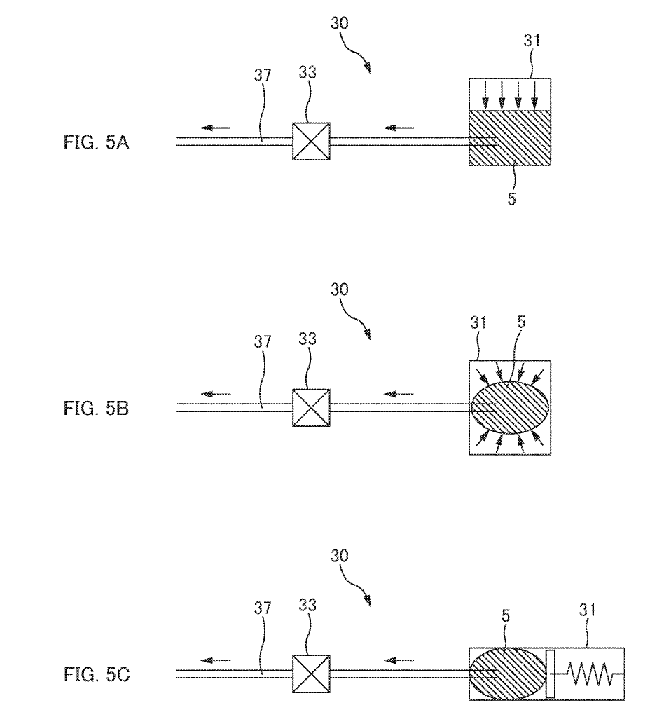

FIG. 5A is a diagram illustrating an example of a configuration of the liquid supply section 30, in accordance with one or more embodiments of the invention. The liquid supply section 30 includes a chamber 31, an open-close section 33, an operation section 35, and the tube 37.

In one or more embodiments of the invention, the chamber 31 is a pressure chamber to apply pressure to the liquid cleaner 5. The liquid cleaner 5 is stored in the chamber 31, and surface pressure is applied to the liquid by a high pressure gas. The liquid cleaner 5 inside the chamber 31 is supplied to the open-close section 33.

The chamber 31 is not limited to a form in which surface pressure is applied to the liquid. FIG. 5B and FIG. 5C are diagrams illustrating configurations of alternative chambers 31, in accordance with one or more embodiments of the invention. As illustrated in FIG. 5B, pressure may be applied to the liquid cleaner 5 by sealing the liquid cleaner 5 inside a bag, and applying pressure to the bag using high pressure gas. Moreover, as illustrated in FIG. 5C, pressure may be applied to the liquid cleaner 5 by applying pressure to a bag using the elastic force of a spring or the like, instead of applying pressure using high pressure gas.

The pressure inside the chamber 31 may sometimes become lower as a result of supplying the liquid cleaner 5. Thus, a configuration may be adopted to raise the pressure of the chamber 31 by operation of the operation section 35. Alternatively, the relative movement (linear motion) between the tool body 10 and the insertion section 20 during cleaning may be utilized to raise the pressure of the chamber 31. Note that the liquid supply section 30 may be configured such that instead of applying pressure to the liquid cleaner 5 using the chamber 31 to supply the liquid cleaner 5, a predetermined amount of liquid cleaner may be sucked out of a reservoir, as in a dispenser pump, so as to supply a predetermined amount of the sucked liquid cleaner.

In one or more embodiments of the invention, the open-close section 33 is a member that opens or closes a flow path of the liquid cleaner 5. The flow path is blocked when the open-close section 33 has closed the flow path, and so the liquid cleaner 5 does not flow along the flow path, and the liquid cleaner 5 is not supplied. The flow path is open when the open-close section 33 has opened the flow path, and the liquid cleaner 5 flows along the flow path under the pressure of the chamber 31, thereby supplying the liquid cleaner 5. Provision of the open-close section 33 in the liquid supply section 30 enables liquid to be prevented from dripping due to being able to block the flow path using the open-close section 33. The open-close section 33 is disposed together with the chamber 31 in the tool body 10 (see FIG. 1).

In one or more embodiments of the invention, the operation section 35 is a section to operate the open-close section 33 (see FIG. 1). In one or more embodiments, the operation section 35 is formed in a button shape, however the operation section 35 may have another form. When the operator presses the operation section 35, the open-close section 33 opens the flow path only for a fixed period of time, such that the predetermined amount of the liquid cleaner 5 flows along the flow path. Note that in order to suppress oversupply of the liquid cleaner 5, a configuration may be adopted in which the open-close section 33 opens the flow path only for the fixed period of time, instead of configuration such that the open-close section 33 continues to keep the flow path open when the operator presses the operation section 35 continuously.

In one or more embodiments of the invention, instead of opening or closing the open-close section 33 using the operation section 35, the open-close section 33 may be opened or closed by utilizing the relative movement (linear motion) between the tool body 10 and the insertion section 20 during cleaning. This enables the open-close section 33 to be opened or closed without providing the operation section 35. Opening or closing the open-close section 33 by utilizing the relative movement (linear motion) between the tool body 10 and the insertion section 20 during cleaning enables the operator to be prevented from forgetting to moisten the cleaning element 3 during cleaning. In contrast thereto, a configuration in which the opening or closing of the open-close section 33 is performed using the operation section 35, in accordance with one or more embodiments, enables a dry cleaning method or a wet cleaning method to be selected as desired due to the operator being able to decide whether or not there is a need to moisten the cleaning element 3.

In one or more embodiments of the invention, the tube 37 is a member configuring a flow path at the downstream side of the open-close section 33. The upstream end of the tube 37 is coupled to the open-close section 33, and the downstream end of the tube 37 is configured by the dispensing port 37A that dispenses the liquid cleaner 5. The dispensing port 37A is disposed at the pressing face 22 so as to enable moistening of the cleaning element 3.

FIG. 6A is an explanatory diagram of a situation in which the liquid cleaner 5 has been dispensed from the dispensing port 37A. In accordance with one or more embodiments, the dispensing port 37A is disposed inside the insertion section 20 facing the cleaning element 3. The dispensing port 37A in the drawing is disposed facing the unused cleaning element 3 at the upstream side of the pressing face 22. This enables the liquid cleaner 5 to be directly dispensed from the dispensing port 37A to the cleaning element 3, so as to moisten the cleaning element 3. However, the dispensing port 37A may be disposed facing the cleaning target so as to moisten the cleaning element 3 indirectly as in an embodiment described later.

In one or more embodiments of the invention, the tube 37 is configured from a flexible material capable of undergoing deformation so as permit relative movement between the tool body 10 and the insertion section 20 in the front-rear direction. The tube 37 is, for example, a silicone tube 37. In such cases in which the tube 37 is made from a flexible material, the position of the dispensing port 37A would be liable to become unstable. Thus in one or more embodiments, the position of the dispensing port 37A is fixed by the tube 37 being retained by the retention groove 253A formed in the leading end cylinder section 253.

In one or more embodiments of the invention, the predetermined amount of the liquid cleaner 5 is dispensed from the dispensing port 37A when the operator presses the operation section 35. In one or more embodiments, due to provision of the guides 211A in the vicinity of the dispensing port 37A to guide the cleaning element 3 in the front-rear direction, the liquid cleaner 5 dispensed onto the cleaning element 3 is not liable to spill outwards in the left-right direction, and instead permeates the cleaning element 3 along the front-rear direction.

In one or more embodiments, the amount of liquid cleaner 5 absorbed is greater than for a cleaning element of thread shape due to the cleaning element 3 having a strip shape. Spillage of the dispensed liquid cleaner 5 is thereby readily suppressed due to employing the strip shaped cleaning element 3.

FIG. 6B is a diagram illustrating a range of the liquid cleaner 5 permeated the cleaning element 3 after the predetermined amount of the liquid cleaner 5 has been supplied. The region indicated by hatching in the drawing indicates the range over which the liquid cleaner 5 permeated the cleaning element 3.

In one or more embodiments, the liquid cleaner 5 permeates the cleaning element 3 up to the pressing face 22 when the predetermined amount of the liquid cleaner 5 has been supplied, in accordance with one or more embodiments of the invention. Thus, the end face of the optical connector can be moistened with the liquid cleaner 5 at the stage when the cleaning element 3 contacts the optical connector during cleaning, even before moving the tool body 10 and the insertion section 20 relative to each other. However, it is sufficient for the cleaning element 3 at the pressing face 22 to be moisten with the liquid cleaner 5 when the cleaning element 3 is fed onto the pressing face 22 during cleaning; so, the liquid cleaner 5 does not necessarily have to permeate the cleaning element 3 up to the pressing face 22 at the stage when the predetermined amount of the liquid cleaner 5 has just been supplied.

Moreover, as illustrated in FIG. 6B, in one or more embodiments of the invention, length L1 is a length up to the pressing face 22 from the upstream end of the range over which the liquid cleaner 5 has permeated when the predetermined amount of the liquid cleaner 5 has been supplied. L1 is set less than L2 (L1>L2) wherein length L2 is a length of the cleaning element 3 fed by the feed mechanism 13 during cleaning. Thus, during cleaning, a portion of the cleaning element 3 not permeated by the liquid cleaner 5 (in the drawing, the cleaning element 3 more toward the upstream side than the upstream end of the range over which the liquid cleaner 5 has permeated) is pressed against the cleaning target after a portion of the cleaning element 3 permeated by the liquid cleaner 5 has been pressed against the cleaning target at the pressing face 22. Namely, this result in dry cleaning (dry wiping) being performed after wet cleaning has been performed. This enables any remaining liquid cleaner 5 to be removed by dry cleaning even if some of the liquid cleaner 5 from the period of wet cleaning still remains on the end face of the optical connector. No residue may be left on the end face of the optical connector.

As described above, the cleaning tool 1 of the first embodiment includes: the head member 21 to press the cleaning element 3 at the pressing face 22 against the cleaning target (for example, an optical connector); the feed mechanism 13 that supplies the cleaning element 3 and collects the cleaning element 3; and the liquid supply section 30 to moisten the cleaning element 3 at the pressing face 22 with the liquid cleaner 5. This thereby enables strongly adhered dirt to be easily removed. Moreover, a cleaning operation using such a cleaning tool is not only completed without effort for the cleaning operation, but is also not liable to be affected by differences in the cleaning techniques of operators.

### Second Embodiment

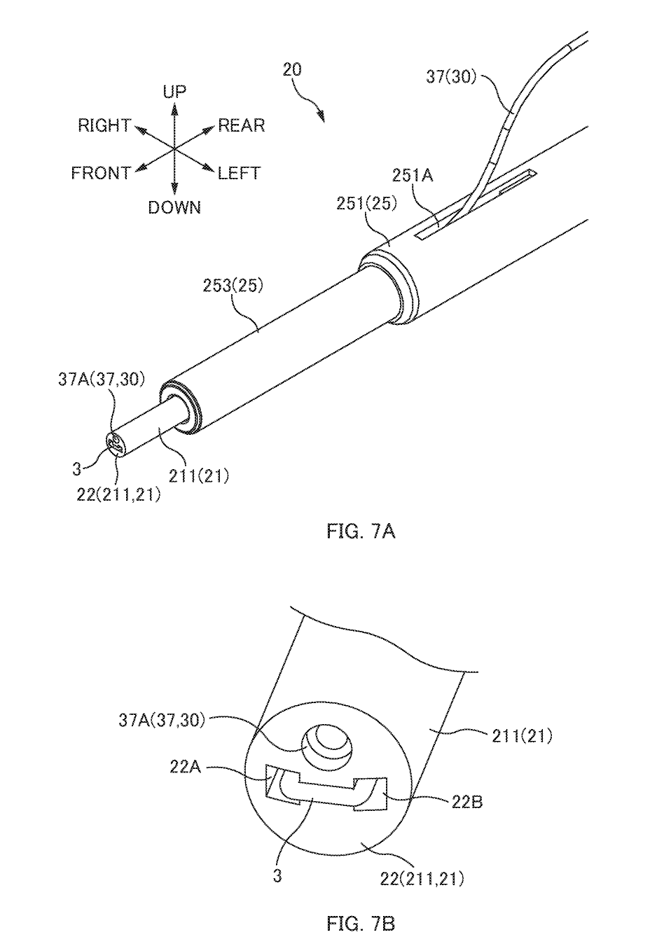

FIG. 7A is a perspective view of an insertion section 20 of a cleaning tool 1 in accordance with a second embodiment. FIG. 7B is an explanatory diagram of a pressing face 22 of a head member 21 and a dispensing port 37A of a liquid supply section 30 in the second embodiment. Substantially similar to the first embodiment, in the second embodiment the cleaning tool 1 includes the head member 21, the feed mechanism 13, and the liquid supply section 30. Substantially similar to the first embodiment, in the second embodiment the head member 21 is configured so as to be capable of rotating about an axis along the front-rear direction.

In the second embodiment as well, the head member 21 presses a cleaning element 3 at a pressing face 22 against a cleaning target. However, in the second embodiment, the cleaning element 3 is thread shaped instead of strip shaped. The feed mechanism 13 is configured so as to supply the thread shaped cleaning element 3 and to collect the thread shaped cleaning element 3.

As illustrated in FIG. 7B, a supply side insertion hole 22A and a return side insertion hole 22B are formed in the pressing face 22 of the head member 21, in accordance with one or more embodiments of the invention. The unused cleaning element 3 supplied from a supply reel 13A is supplied through the supply side insertion hole 22A onto the pressing face 22, and the used cleaning element 3 is collected from the pressing face 22 through the return side insertion hole 22B and collected onto a take-up reel 13B. The cleaning element 3 is entrained around the pressing face 22 from the supply side insertion hole 22A to the return side insertion hole 22B. The supply side insertion hole 22A is positioned at the upstream side on the pressing face 22, and the return side insertion hole 22B is positioned at the downstream side on the pressing face 22.

As illustrated in FIG. 7B, the dispensing port 37A of the liquid supply section 30 is formed in the pressing face 22 of the head member 21, in accordance with one or more embodiments of the invention. The liquid supply section 30 supplies the liquid cleaner 5 onto the pressing face 22 through the tube 37, and dispenses the liquid cleaner 5 at the dispensing port 37A. During cleaning, since the pressing face 22 of the head member 21 faces toward the cleaning target (for example, an optical connector), the dispensing port 37A also faces toward the cleaning target during cleaning. In the second embodiment, the liquid cleaner 5 dispensed from the dispensing port 37A is not directly dispensed toward the cleaning element 3, and is instead dispensed toward the cleaning target. However, due to the liquid cleaner 5 coated onto the cleaning target contacting the cleaning element 3, the liquid supply section 30 is able to indirectly moisten the cleaning element 3 at the pressing face 22 with the liquid cleaner 5. Thus, strongly adhered dirt can be easily removed in the second embodiment due to being able to perform wet cleaning.

In the second embodiment, preferably an open-close section 33 is opened or closed by utilizing the relative movement (linear motion) between the tool body 10 and the insertion section 20 during cleaning instead of opening or closing the open-close section 33 using an operation section 35 as in the first embodiment. Thus when the liquid cleaner 5 is being dispensed from the dispensing port 37A, the cleaning element 3 at the pressing face 22 is readily indirectly moistened with the liquid cleaner 5 due to the pressing face 22 being in a state facing toward the cleaning target.

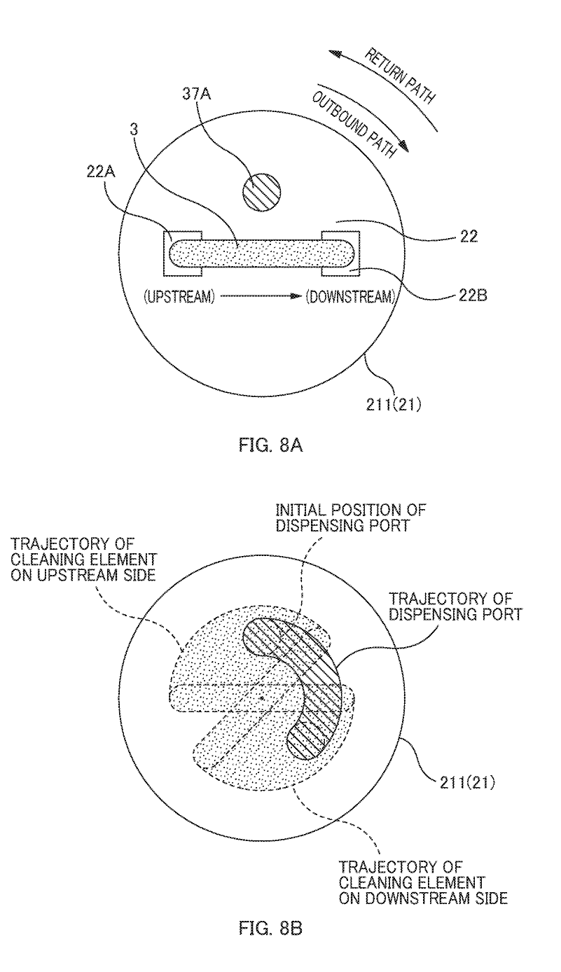

FIG. 8A is an explanatory diagram regarding a positional relationship between the cleaning element 3 at the pressing face 22 and the dispensing port 37A, in accordance with one or more embodiments of the invention. As illustrated in the drawing, the dispensing port 37A is disposed at a different position to the position of the cleaning element 3 when the pressing face 22 is viewed from the front. Note that were the dispensing port 37A to be disposed behind (at the rear side of) the cleaning element 3, then there would be a height difference behind the cleaning element 3, making it difficult to press the cleaning element 3 against the cleaning target at the pressing face 22. Thus, in one or more embodiments, the dispensing port 37A is disposed at a different position to the position of the cleaning element 3.

As already explained, the head member 21 utilizes the relative movement between the tool body 10 and the insertion section 20 in the front-rear direction during cleaning to rotate in a rotation direction about an axis along the front-rear direction, in accordance with one or more embodiments of the invention. The rotation of the head member 21 when this occurs is a to-and-fro reciprocating rotation (out and return rotation) over a predetermined range instead of continuous rotation in one direction. Namely, an operator presses the cleaning element 3 at the pressing face 22 against the optical connector, and when the tool body 10 is moved forward in this state (during a push action), the head member 21 rotates in the outbound path direction of FIG. 8A. Moreover, when the operator separates the cleaning element from the optical connector (during a pull action), the insertion section 20 returns to its original position relative to the tool body 10, and the head member 21 rotates in the return path direction of FIG. 8A.

FIG. 8B is an explanatory diagram of the trajectory of the cleaning element 3 and the trajectory of the dispensing port 37A when the head member 21 is rotated during cleaning, in accordance with one or more embodiments of the invention. When the head member 21 rotates about an axis along the front-rear direction, the cleaning element 3 at the pressing face 22 and the dispensing port 37A also move by rotation about the rotation axis. In FIG. 8B, the trajectory of the dispensing port 37A when the head member 21 is rotated is indicated by the diagonal hatching. Moreover, in FIG. 8B, the trajectory of the cleaning element 3 at the pressing face 22 when the head member 21 is rotated is indicated by the dot pattern hatching.

In one or more embodiments, as illustrated in FIG. 8B, the trajectory of the dispensing port 37A when the head member 21 is rotated, and the trajectory of the cleaning element 3 at the pressing face 22 when the head member 21 is rotated, overlap with each other. Due to the liquid cleaner 5 being coated onto locations of the cleaning target facing the trajectory of the dispensing port 37A, as long as there is overlap between the trajectory of the cleaning element 3 and the trajectory of the dispensing port 37A, the cleaning element 3 can be moistened with the liquid cleaner 5 due to the cleaning element 3 contacting the locations coated with the liquid cleaner 5.

Moreover, in one or more embodiments, as illustrated in FIG. 8B, the trajectory of the dispensing port 37A when the head member 21 is rotated, and the trajectory of the cleaning element 3 at the upstream side (at the side near to the supply side insertion hole 22A) of the pressing face 22 when the head member 21 is rotated, overlap with each other. This approach is adopted because it is effective to moisten the cleaning element 3 at the upstream side when considering that the cleaning element 3 at the pressing face 22 is fed from the upstream side (the supply side insertion hole 22A side) to the downstream side (the return side insertion hole 22B side).

Moreover, as illustrated in FIG. 8B, in one or more embodiments, the initial position of the dispensing port 37A prior to rotation of the head member 21, and the trajectory of the cleaning element 3 at the upstream side (the side near to the supply side insertion hole 22A) of the pressing face 22 when the head member 21 is rotated on the outbound path, overlap with each other. The cleaning element 3 at the upstream side (the side near to the supply side insertion hole 22A) can thereby be moistened with the liquid cleaner 5 partway along the outbound path (during the push action described above), with this being advantageous due to the cleaning element 3 at the upstream side already being in a moistened state at the stage the head member 21 is rotated along the return path. Note that, in cases in which there is no such overlap with the initial position of the dispensing port 37A—as with the trajectory of the cleaning element 3 at the downstream side in FIG. 8B—the cleaning element 3 is moistened partway along the return path, which may be disadvantageous in wet cleaning.

### OTHER EMBODIMENTS

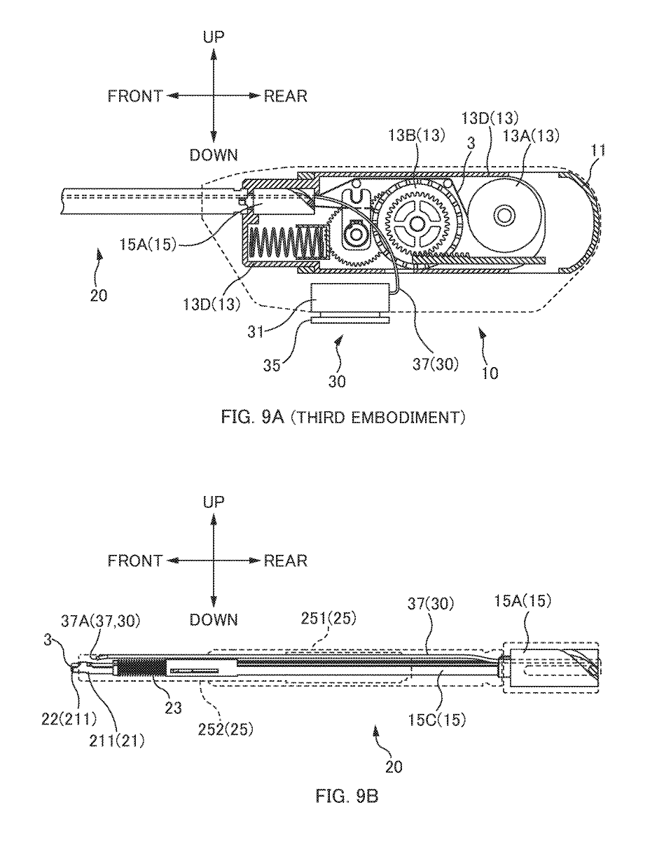

FIG. 9A is a diagram illustrating an internal configuration of a tool body 10 of a cleaning tool 1 in accordance with a third embodiment. FIG. 9B is a diagram illustrating an internal configuration of an insertion section 20 of the cleaning tool 1 of the third embodiment.

As illustrated in FIG. 9A, in the third embodiment, a chamber 31 of a liquid supply section 30 is provided on the inside of a case body 11. An operation section 35 is formed on the outside of the case body 11, and an operator is able to operate the operation section 35 while holding the tool body 10. The upstream end of a tube 37 is coupled to a non-illustrated open-close section 33 inside the chamber 31. The tube 37 is led inside the moving body 13D, and the tube 37 is led from the rear side of a cylindrical shaped rotating cylinder 15A of a rotating body 15 up to a leading end cylinder section 253. The downstream end of the tube 37 configures a dispensing port 37A that dispenses a liquid cleaner 5. In the third embodiment as well, the dispensing port 37A is disposed so as to be able to moisten a cleaning element 3 at a pressing face 22.

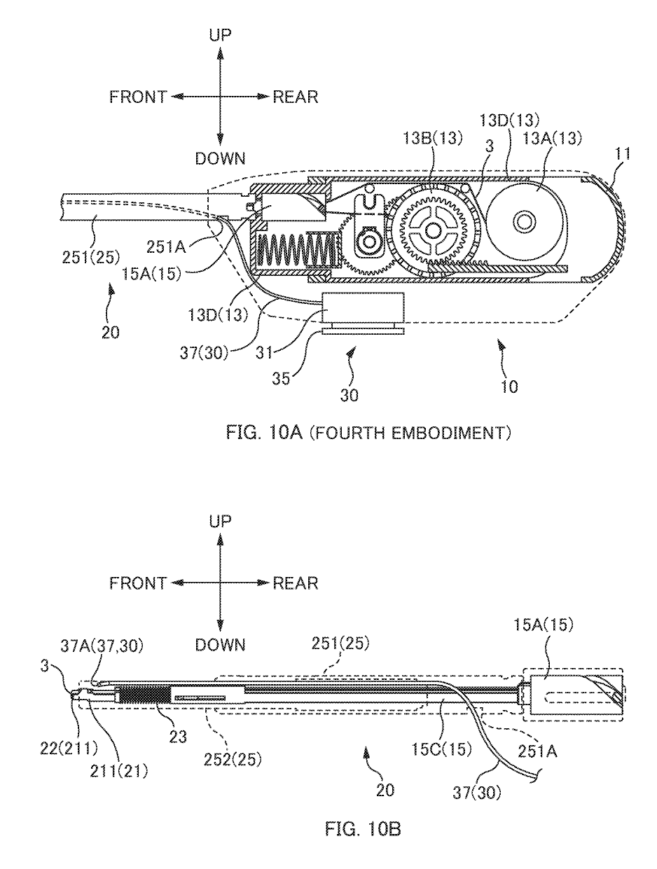

FIG. 10A is a diagram illustrating an internal configuration of a tool body 10 of a cleaning tool 1 in accordance with a fourth embodiment. FIG. 10B is a diagram illustrating an internal configuration of an insertion section 20 of the cleaning tool 1 of the fourth embodiment.

As illustrated in FIG. 10A, also in the fourth embodiment, a chamber 31 of a liquid supply section 30 is provided inside a case body 11. An operation section 35 is formed on the outside of the case body 11, and an operator is able to operate the operation section 35 while holding the tool body 10. In the fourth embodiment, a lead-in hole 251A is formed in a base cylinder section 251 at a location inside the case body 11, and a tube 37 is led into the lead-in hole 251A through a gap between the case body 11 and a moving body 13D, and is led from the lead-in hole 251A up to a leading end cylinder section 253. The downstream end of the tube 37 configures a dispensing port 37A that dispenses a liquid cleaner 5. In the fourth embodiment as well, the dispensing port 37A is disposed so as to be able to moisten a cleaning element 3 at a pressing face 22.

As described for the third and fourth embodiments, the tube 37 may be laid inside the cleaning tool 1. In such cases, the tube 37 is preferably led inside the cylinder body 25 at the inside of the case body 11. This may enable damage to the tube 37 to be avoided due to the tube 37 not being externally exposed.

In one or more embodiments, the cleaning tool 1 includes: the head member 21 to press the cleaning element 3 at the pressing face 22 against the cleaning target (for example, an optical connector); the feed mechanism 13 to supply the cleaning element 3 and collect the cleaning element 3; and the liquid supply section 30 to moisten the cleaning element 3 at the pressing face 22 with the liquid cleaner 5. Such a cleaning tool 1 enables strongly adhered dirt to be easily removed due to being able to implement wet cleaning.

In one or more embodiments, the liquid supply section 30 includes the open-close section 33 capable of blocking the flow path of the liquid cleaner 5, and the liquid cleaner 5 flows along the flow path and is supplied when the open-close section 33 has opened the flow path (see, for example, FIG. 5A to FIG. 5C). Dripping of the liquid cleaner 5 can be prevented by the open-close section 33 blocking the flow path.

In one or more embodiments, the operation section 35 is provided to operate the open-close section 33. This enables the operator to decide whether or not there is a need to moisten the cleaning element 3.

In one or more embodiments, the cleaning tool 1 includes the tool body 10 and the insertion section 20 that includes the head member 21 and is capable of moving in a predetermined direction (the front-rear direction) relative to the tool body 10. The open-close section 33 is then opened or closed by relative movement between the tool body 10 and the insertion section 20 during cleaning (when cleaning the cleaning target by moving the tool body 10 and the insertion section 20 relative to each other while pressing the cleaning element 3 at the pressing face 22 against the cleaning target). This enables the open-close section 33 to be opened or closed without providing the operation section 35, enabling an operator to be prevented from forgetting to moisten the cleaning element 3 during cleaning.

In one or more embodiments, a predetermined amount of the liquid cleaner 5 is supplied when the open-close section 33 has opened the flow path. This enables oversupply of the liquid cleaner 5 to be suppressed.

In one or more embodiments, the liquid cleaner 5 permeates the cleaning element 3 up to the pressing face 22 when the predetermined amount of the liquid cleaner 5 has been supplied (see, for example, FIG. 6B). This enables the end face of the optical connector to be moistened with the liquid cleaner 5 at the stage when the cleaning element 3 has contacted the optical connector during cleaning.

In one or more embodiments, L1 is set less than L2 (L1>L2) wherein L1 is the length up to the pressing face 22 from the upstream end of the range over which the liquid cleaner 5 has permeated the cleaning element 3 when the predetermined amount of the liquid cleaner 5 has been supplied (see FIG. 6B), and L2 is the length of the cleaning element 3 fed by the feed mechanism 13 during cleaning. Doing so enables dry cleaning (dry wiping) to be performed after wet cleaning has been performed.

In one or more embodiments, during cleaning, at the pressing face 22, a portion of the cleaning element 3 not permeated by the liquid cleaner 5 is pressed against the cleaning target after a portion of the cleaning element 3 permeated by the liquid cleaner 5 has been pressed against the cleaning target. This enables dry cleaning (dry wiping) to be performed after wet cleaning has been performed, enabling residue of the liquid cleaner 5 to be suppressed from remaining on the cleaning target.

In one or more embodiments, the liquid supply section 30 includes the dispensing port 37A that dispenses the liquid cleaner 5 to the cleaning element 3 (see, for example, FIG. 6A). This enables the cleaning element 3 to be moisten by directly dispensing the liquid cleaner 5 from the dispensing port 37A to the cleaning element 3.

In one or more embodiments, the head member 21 includes the guides 211A at the dispensing port 37A to guide the cleaning element 3 (see, for example, FIG. 6A). This enables spilling of the liquid cleaner 5 to be suppressed by the guides 211A.

In one or more embodiments, the cleaning element 3 is configured in a strip shape. The strip shaped cleaning element 3 absorbs a large amount of liquid cleaner 5, enabling spilling of the liquid cleaner 5 to be suppressed.

In one or more embodiments, the liquid supply section 30 includes the dispensing port 37A facing the cleaning target (for example, an optical connector) (see, for example, FIG. 7B), and the liquid cleaner 5 dispensed from the dispensing port 37A contacts the cleaning element 3 during cleaning. This enables the cleaning element 3 at the pressing face 22 to be indirectly moistened with the liquid cleaner 5.

In one or more embodiments, the head member 21 is configured so as to rotate during cleaning (see, for example, FIG. 8A), and the trajectory of the dispensing port 37A when the head member 21 rotates, and the trajectory of the cleaning element 3 at a pressing member when the head member 21 rotates, overlap with each other (see, for example, FIG. 8B). This enables the cleaning element 3 at the pressing face 22 to be indirectly moistened with the liquid cleaner 5.

In one or more embodiments, the trajectory of the dispensing port 37A when the head member 21 rotates and the trajectory of the cleaning element 3 at the upstream side of the pressing member when the head member 21 rotates, overlap with each other (see FIG. 8B). This is because it is more effective to moisten the cleaning element 3 at the upstream side due to the cleaning element 3 being supplied from the upstream side to the downstream side.

In one or more embodiments, the head member 21 is configured so as to perform to-and-fro reciprocating rotation instead of rotating continuously in one direction, and the initial position of the dispensing port 37A prior to rotation of the head member 21, and the trajectory of the cleaning element 3 on the upstream side of the pressing member when the head member 21 is rotated during the outbound path, overlap with each other (see FIG. 8B). This enables the cleaning element 3 to be moistened with the liquid cleaner 5 on the upstream side (the side in the vicinity of the supply side insertion hole 22A) partway along the outbound path.

One or more embodiments of the invention relate to a cleaning method. In the cleaning method, a feed process is performed to supply the cleaning element 3 and to collect the cleaning element 3, a moistening process is performed to moisten the cleaning element 3 at the pressing face 22 with the liquid cleaner 5, and a pressing process is performed to press the moistened cleaning element 3 against the cleaning target (for example, an optical connector) at the pressing face 22. Such a cleaning method enables strongly adhered dirt to be easily removed due to being able to implement wet cleaning.

The foregoing embodiments are for facilitating the understanding of the invention, and are not to be construed as to limit the invention. Needless to say, embodiments of the invention may be modified and/or improved without departing from the invention, and the invention encompasses equivalents thereof.

### REFERENCE SIGNS LIST

1: cleaning tool; 3: cleaning element; 5: liquid cleaner; 10: tool body; 11: case body; 11A: rack; 11B: spring seat; 11C: insertion protrusion (rotation mechanism); 13: feed mechanism; 13A: supply reel; 13B: take-up reel; 13C: pinion; 13D: moving body; 13E: coil spring; 15: rotating body; 15A: rotating cylinder; 15B: cam groove (rotation mechanism); 15C: guide; 15D: head support; 20: insertion section; 21: head member; 211: head; 211A: guide; 22: pressing face; 22A: supply side insertion hole; 22B: return side insertion hole; 213: flange; 215: base end; 23: head spring; 25: cylinder body; 251: base cylinder section; 251A: lead-in hole; 253: leading end cylinder section; 253A: retention groove; 30: liquid supply section; 31: chamber; 33: open-close section; 35: operation section; 37: tube; 37A: dispensing port.

1. A cleaning tool comprising:
a head member that presses a cleaning element at a pressing face against a cleaning target;
a feed mechanism that supplies the cleaning element to the pressing face and that collects the cleaning element from the pressing face; and
a liquid supply section that supplies a liquid cleaner and moistens the cleaning element at the pressing face with the liquid cleaner.

2. The cleaning tool according to claim 1,
wherein the liquid supply section includes an open-close section that blocks a flow path of the liquid cleaner; and
wherein the liquid cleaner flows in the flow path and is supplied when the open-close section has opened the flow path.

3. The cleaning tool according to claim 2, wherein an operation section is provided to operate the open-close section.

4. The cleaning tool according to claim 2,
wherein the cleaning tool further comprises:
a tool body, and
an insertion section including the head member and that moves in a predetermined direction relative to the tool body; and
wherein the open-close section is opened or closed by relative movement between the tool body and the insertion section when cleaning the cleaning target by moving the tool body and the insertion section relative to each other while pressing the cleaning element at the pressing face against the cleaning target.

5. The cleaning tool according to claim 2, wherein a predetermined amount of the liquid cleaner is supplied when the open-close section has opened the flow path.

6. The cleaning tool according to claim 5, wherein, when the predetermined amount of the liquid cleaner has been supplied, the liquid cleaner permeates the cleaning element up to the pressing face.

7. The cleaning tool according to claim 5,
wherein L1<L2 is satisfied,
wherein L1 is a length up to the pressing face from an upstream end of a range over which the liquid cleaner has permeated the cleaning element when the predetermined amount of the liquid cleaner has been supplied, and
wherein L2 is a length of the cleaning element fed by the feed mechanism when cleaning the cleaning target by pressing the cleaning element at the pressing face against the cleaning target.

8. The cleaning tool according to claim 1, wherein, when cleaning the cleaning target by pressing the cleaning element at the pressing face against the cleaning target, at the pressing face, a portion of the cleaning element not permeated by the liquid cleaner is pressed against the cleaning target after a portion of the cleaning element permeated by the liquid cleaner has been pressed against the cleaning target.

9. The cleaning tool according to claim 1, wherein the liquid supply section includes a dispensing port that dispenses the liquid cleaner to the cleaning element.

10. The cleaning tool according to claim 9, wherein the head member includes a guide that guides the cleaning element at the dispensing port.

11. The cleaning tool according to claim 9, wherein the cleaning element has a strip shape.

12. The cleaning tool according to claim 1,
wherein the liquid supply section includes a dispensing port facing the cleaning target; and
wherein the liquid cleaner dispensed from the dispensing port contacts the cleaning element when cleaning the cleaning target by pressing the cleaning element at the pressing face against the cleaning target.

13. The cleaning tool according to claim 12,
wherein the head member rotates when cleaning the cleaning target by pressing the cleaning element at the pressing face against the cleaning target; and
wherein a trajectory of the dispensing port when the head member is rotated and a trajectory of the cleaning element at the pressing face when the head member is rotated overlap with each other.

14. The cleaning tool according to claim 13,
wherein the cleaning element is fed from an upstream side to a downstream side at the pressing face when cleaning the cleaning target by pressing the cleaning element at the pressing face against the cleaning target; and
wherein a trajectory of the dispensing port when the head member is rotated and a trajectory of the cleaning element on the upstream side at the pressing face when the head member is rotated overlap with each other.

15. The cleaning tool according to claim 14,
wherein the head member performs a to-and-from reciprocating rotation when cleaning the cleaning target by pressing the cleaning element at the pressing face against the cleaning target; and
wherein an initial position of the dispensing port prior to rotation of the head member and a trajectory of the cleaning element on the upstream side at the pressing face when the head member is rotated during an outbound path overlap with each other.

16. A cleaning method comprising:
supplying a cleaning element to a pressing face of a head member and collecting the cleaning element from the pressing face;
supplying a liquid cleaner to moisten the cleaning element at the pressing face with the liquid cleaner; and
pressing the cleaning element moistened with the liquid cleaner against the cleaning target at the pressing face.
